(19) United States
(12) Patent Application Publication
(10) Pub. No.: US 2013/0341949 A1
(43) Pub. Date: Dec. 26, 2013

(54) TRUCK BED EXTENSION APPARATUS

(71) Applicant: James R. Bernthisel, Bowling Green, OH (US)

(72) Inventor: James R. Bernthisel, Bowling Green, OH (US)

(21) Appl. No.: 13/530,682

(22) Filed: Jun. 22, 2012

(51) Int. Cl. B62D 33/027

(52) U.S. Cl. 296/26.09

(57) ABSTRACT

A truck bed extension apparatus including a working table movably coupled to a truck bed. The working table is laterally moveable between a retracted position and an extended position. In the retracted position, the working table is entirely within the truck bed. Conversely, in the extended position, the working table extends from adjacent wheel wells of the truck bed to past a tailgate thereof. A compartment formed between the working table of the truck bed extension apparatus and a bottom wall of the truck bed receives a drawer therein. The drawer may be slideably coupled to the working table of the truck bed extension apparatus if desired. The drawer is laterally moveable between a closed position and a fully-open position. An operation of the drawer is independent of an operation of the working table.

### CROSS REFERENCE TO RELATED APPLICATION

This application claims the benefit of U.S. Provisional Patent Application Ser. No. 61/499,886 filed Jun. 22, 2011, the entire disclosure of which is hereby incorporated herein by reference.

### FIELD OF THE INVENTION

The invention relates to a truck bed extension apparatus, and more particularly, to a truck bed extension apparatus with an extensible drawer.

### BACKGROUND OF THE INVENTION

Presently known truck bed extension apparatuses are used for temporarily extending a size of a bed of a truck to accommodate and transport oversized loads. Typically, the extension apparatus includes an elongate planar working table shaped to fit within the truck bed, and which may be rubber lined. The table is slideably coupled to an undercarriage disposed between the table and the truck bed to support the table. A lateral movement of the undercarriage permits the table to slide from a retracted position, entirely within the truck bed, to an extended position. In the extended position, the table serves to extend a useable length of the truck bed by extending from just behind rear wheels of the truck to past an end of an opened tailgate on the truck. However, the undercarriage of such extension apparatus occupies a significant portion of space underneath the plate. Articles needed to be stored or transported in the truck bed have to be placed on top of the plate. Accordingly, a storing capacity of the truck bed is significantly reduced by the extension apparatus.

Accordingly, it would be desirable to produce an extension apparatus, which extends a useable length of a truck bed, while maximizing a storage capacity thereof.

### SUMMARY OF THE INVENTION

In concordance and agreement with the present invention, a truck bed extension apparatus, which extends a useable length of a truck bed, while maximizing a storage capacity thereof, has surprisingly been discovered.

In one embodiment, the extension apparatus comprises: a working table movably coupled to a mounting structure, the working table selectively positionable between a retracted position and an extended position; and an extensible drawer disposed between the working table and the mounting structure, the extensible drawer selectively positionable between a closed position and a fully-open position.

In another embodiment, the extension apparatus comprises: a working table movably coupled to a mounting structure, the working table selectively positionable between a retracted position and an extended position; and an extensible drawer movably coupled to the working table between the working table and the mounting structure, the extensible drawer selectively positionable between a closed position and a fully-open position.

In yet another embodiment, the extension apparatus comprises: a working table movably coupled to a truck bed, the working table selectively positionable between a retracted position and an extended position; and an extensible drawer movably coupled to the working table between the working table and the truck bed, the extensible drawer selectively positionable between a closed position and a fully-open position, wherein the extensible drawer is configured to be accessible to a user when the working table is positioned in at least one of the extended position and an intermediate position between the extended position and the retracted position.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view of a truck bed extension apparatus disposed in a truck bed according to an embodiment of the invention, showing the truck bed extension apparatus in a retracted position and a drawer disposed in a compartment formed by the truck bed extension apparatus in a closed position indicated by solid lines and in a fully-open position indicated by dashed lines;

FIG. 2 is a perspective view of the truck bed extension apparatus illustrated in FIG. 1, showing the truck bed extension apparatus in an extended position and the drawer disposed in the compartment formed by the truck bed extension apparatus in the closed position;

FIG. 3 is a perspective view of the truck bed extension apparatus illustrated in FIGS. 1-2, showing the truck bed extension apparatus in an intermediate position between the retracted position and the extended position and the drawer disposed in the compartment formed by the truck bed extension apparatus in the fully-open position;

FIG. 4 is a perspective view of a truck bed extension apparatus disposed in a truck bed according to another embodiment of the invention, showing the truck bed extension apparatus in a retracted position and a drawer disposed in a compartment formed by the truck bed extension apparatus in a closed position;

FIG. 5 is a perspective view of the truck bed extension apparatus illustrated in FIG. 4, showing the truck bed extension apparatus in the retracted position and the drawer disposed in the compartment formed by the truck bed extension apparatus in a fully-open position;

FIG. 6 is a perspective view of the truck bed extension apparatus illustrated in FIGS. 4-5, showing the truck bed extension apparatus in an extended position and the drawer disposed in the compartment formed by the truck bed extension apparatus in the closed position; and

FIG. 7 is a perspective view of the truck bed extension apparatus illustrated in FIGS. 4-6, showing the truck bed extension apparatus in the extended position and the drawer disposed in the compartment formed by the truck bed extension apparatus in the fully-open position.

### DESCRIPTION OF THE PREFERRED EMBODIMENTS

The following detailed description and appended drawings describe and illustrate various exemplary embodiments of the invention. The description and drawings serve to enable one skilled in the art to make and use the invention, and are not intended to limit the scope of the invention in any manner.

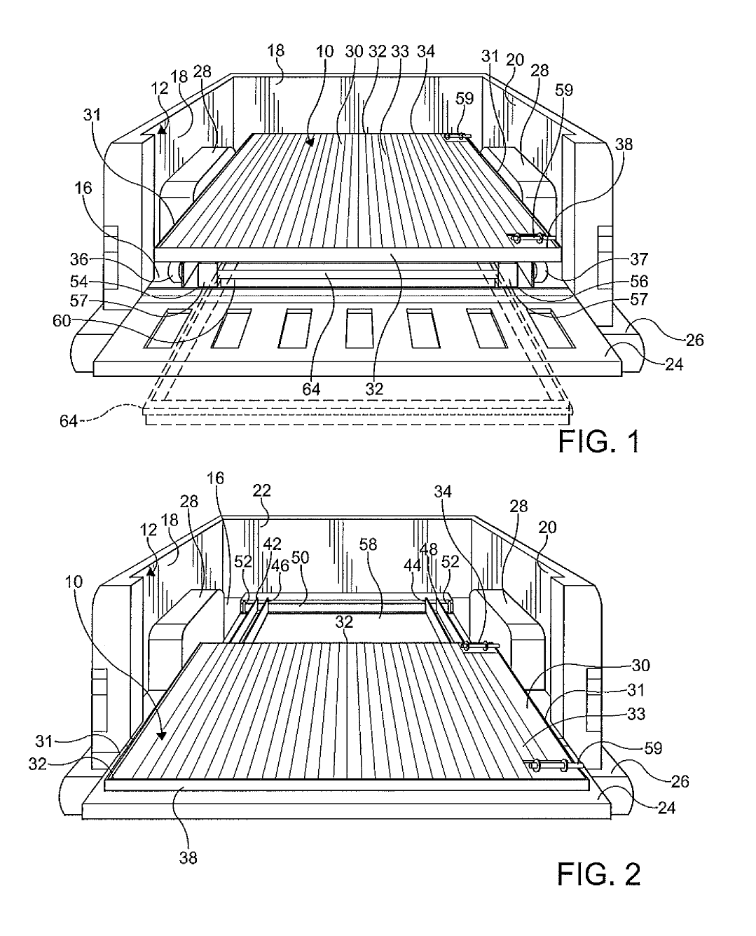

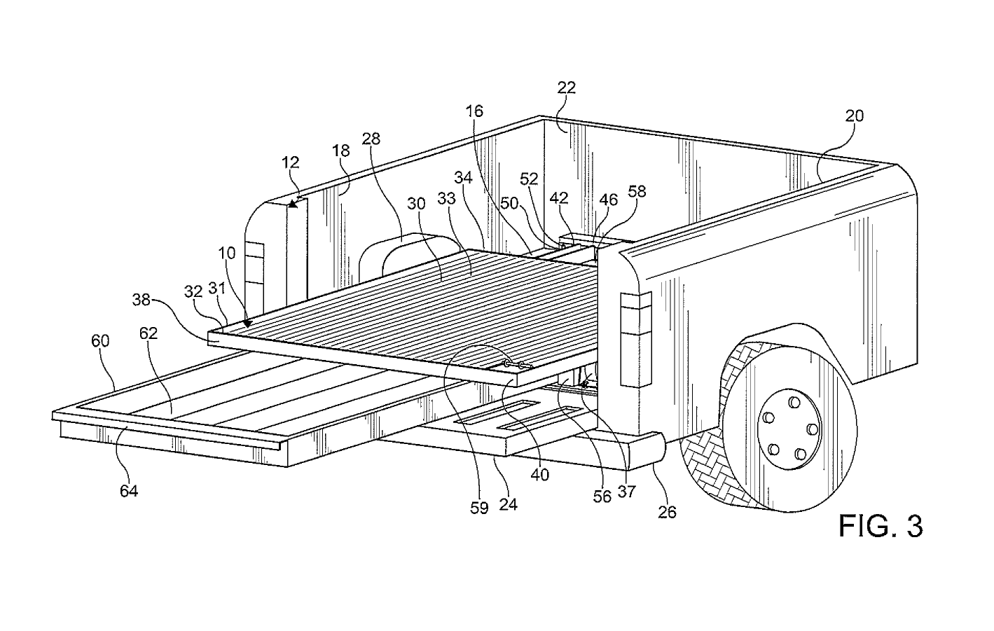

FIGS. 1-3 show an extension apparatus 10 for use in a truck bed 12 according to an embodiment of the invention. It is understood that the extension apparatus 10 is not limited to use in a truck bed 12 and can be used with other mounting structures as desired. The truck bed 12 has a bottom wall 16, opposing upright sidewalls 18, 20, a front wall 22, and a pivotal tailgate 24. The tailgate 24 is located above a rear bumper 26, shown in FIG. 3, and pivotal between an open position and a closed position. An interior of the truck bed 12 includes upwardly projecting wheel wells 28 which are centrally formed in each sidewall 18, 20.

As shown in FIGS. 1-3, the extension apparatus 10 includes an elongate, substantially planar working table 30. The working table 30 is generally rectangular shaped, and is sized to fit within the truck bed 12 between the wheel wells 28. In certain embodiments, the working table 30 includes a pair of opposing side members 31 coupled together by end members 32 extending therebetween. The members 31, 32 can be formed from any suitable material such as aluminum, steel, stainless steel, hardened plastic, or other suitable lightweight rigid material, for example. The members 31, 32 form a frame which receives and retains a rigid plate (not shown) such as a sheet of aluminum, steel, stainless steel, hardened plastic, plywood, oriented strand board (OSB), medium density fiberboard (MDF), or other suitable lightweight rigid material, for example. It is understood that the side members 31 and the end members 32, as well as the plate can be integrally formed if desired to simplify a manufacture of the working table 30.

An upper surface of the working table 30 may receive thereon or be coated with a non-slip material 33 such as a rubber material, for example. A lower surface of the working table 30 includes a first pair of spaced-apart rollers (not shown) affixed thereto adjacent a front edge 34 of the working table 30 proximate the front wall 22 of the truck bed 12. A second pair of spaced-apart rollers 36, 37 shown in FIGS. 1 and 3, is affixed to the bottom wall 16 of the truck bed 12 proximate the tailgate 24 and rollingly contacts the lower surface of the working table 30. The first pair of rollers and the second pair of roller 36, 37 permit a lateral movement along a longitudinal axis of the working table 30 from a retracted position entirely within the truck bed 12, as shown in FIG. 1, to an extended position, as shown in FIG. 2. In the extended position, the working table 30 increases a useable length of the truck bed 12 by extending from adjacent the wheel wells 28 to past the tailgate 24. It is understood that the lateral movement of the working table 30 can be caused by a manual actuation (e.g. a user) or an automatic actuation (e.g. a drive motor), for example. Additionally, a rear edge 38 of the working table 30 may have at least one reflector (not shown) disposed thereon to indicate to other motorists a location of the working table 30 during use thereof.

As shown in FIG. 2, the working table 30 is slidingly coupled to the truck bed 12 by a pair of spaced-apart U-shaped rails 42, 44 for receiving the first pair of rollers adjacent the front edge 34 of the working table 30 therein, It is understood that the working table 30 can be slidingly coupled to the truck bed 12 by other means as desired such as by ball bearing slides, roller bearing slides, rack and pinion gears, and the like, for example. The rails 42, 44 are disposed in the truck bed 12 substantially parallel to the sidewalls 18, 20. The rails 42, 44 guide the lateral movement of the working table 30 between the retracted position and the extended position. A first end 46, 48 of the rails 42, 44, respectively, is interconnected to a frame rail 50 which is fixedly coupled to the truck bed 12. The frame rail 50 shown is coupled to the truck bed 12 by fasteners 52. However, it is understood that the frame rail 50 and the rails 42, 44 can be fixedly or releaseably coupled to the truck bed 12 by any means as desired such as by fasteners, quick release connectors, welds, clamps, adhesive, and the like, for example. A second end 54, 56 of the rails 42, 44, respectively, can also fixedly or releaseably coupled to the truck bed 12 by any means as desired such as by fasteners, quick release connectors, welds, clamps, adhesive, and the like, for example. Each of the second ends 54, 56 may include an end cap 57 to militate against undesired disengagement of the working table 30 from the rails 42, 44.

As shown in FIG. 2, the rails 42, 44 and the working table 30 define a compartment 58 therebetween. It is understood that the compartment 58 can have any size and shape as desired. The size of the compartment 58 can be modified by adjusting a spacing between the rails 42, 44, a height of the rails 42, 44, a width of the rails 42, 44, and a spacing between the bottom wall 16 of the truck bed 12 and the working table 30, for example. The rollers 36, 37 proximate the tailgate 24 are located outside of the second ends 54, 56 of the rails 42, 44, between the rails 42, 44 and the sidewalls 18, 22 of the truck bed 12. The working table 30 may be releaseably secured in the retracted position within the truck bed 12 or in the extended position by a plurality of locking mechanisms 59. It is understood that the locking mechanism 59 can be any locking mechanism as desired such as a locking pin, a hook and eye latch, a push button switch, a toggle clamp, and the like, for example.

A drawer 60 is slidingly disposed in the compartment 58. The drawer 60 shown is selectively positionable between a closed position, as indicated by solid line in FIG. 1, and a fully-open position, as indicated by dashed lines in FIG. 1 and solid lines in FIG. 3. The drawer 60 operates independently from an operation of the working table 30. The drawer 60 is generally rectangular shaped and is sized to fit within the compartment 58. In a non-limiting example, the drawer 60 has a width of about four feet, a length of about six feet, and a depth of about three inches. It is understood that the drawer 60 can have any size and shape as desired. The drawer 60 may be formed from any suitable material such as aluminum, steel, stainless steel, hardened plastic, or any other lightweight rigid material, for example, and formed to include features to maximize a strength and a rigidity thereof such as a plurality of protuberances, for example. A bottom surface of an interior of the drawer 60 may receive thereon or be coated with a non-slip material 62 such as a rubber material, for example. A lower surface of the drawer 60 may include a plurality of rollers (not shown) affixed thereto to facilitate a rolling contact between the drawer 60 and the bottom wall 16 of the truck bed 12. The drawer 60 may also include a handle 64 formed therein or disposed thereon to facilitate an opening and a closing of the drawer 60 by a manual means. It is understood that the drawer 60 can be configured to be opened and closed by an automated means such as by a drive motor, for example, if desired. It is further understood that the drawer 60 can include a locking mechanism (not shown) to militate against undesired opening of the drawer 60 or a lockable lid (not shown) to militate against undesired access to the interior of the drawer 60.

In operation, when an extended truck bed 12 is desired, the tailgate 24 is pivoted to the open position and the locking mechanisms 59 of the working table 30 are released. The working table 30 is then laterally moved from the retracted position to the extended position. As the working table 30 is moved to the extended position, the first pair of rollers travels within the rails 42, 44 from the first ends 46, 48 thereof towards the second ends 54, 56 and the lower surface of the working table 30 rollingly contacts the second pair of rollers 36, 37. Once in the extended position, the working table 30 is releaseably secured by at least one of the locking mechanisms 59 to maintain the working table 30 in the extended position.

When the extended truck bed 12 is no longer desired, the locking mechanism 59 maintaining the working table 30 in the extended position is released. Thereafter, the working table 30 is laterally moved from the extended position to the retracted position. As the working table 30 is moved to the retracted position, the first pair of rollers travels within the rails 42, 44 from the second ends 54, 56 thereof towards the first ends 46, 48, and the lower surface of the working table 30 rollingly contacts the second pair of rollers 36, 37. Once in the retracted position, the working table 30 is releaseably secured by at least one of the locking mechanisms 59 to maintain the working table 30 in the retracted position. The tailgate 24 is then pivoted and secured in the closed position.

When access to the drawer 60 is desired, the working table 30 is positioned in the retracted position, as shown in FIG. 1, or an intermediate position between the retracted position and the extended position, as shown in FIG. 3. The drawer 60 is then opened using either the manual means or the automated means. Once access to the interior of the drawer 60 is no longer desired, the drawer 60 is then closed using either the manual means or the automated means.

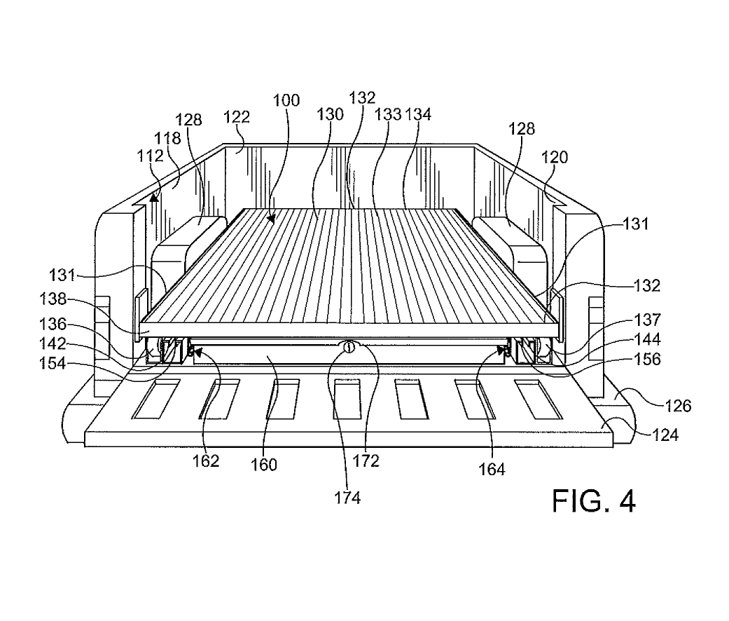

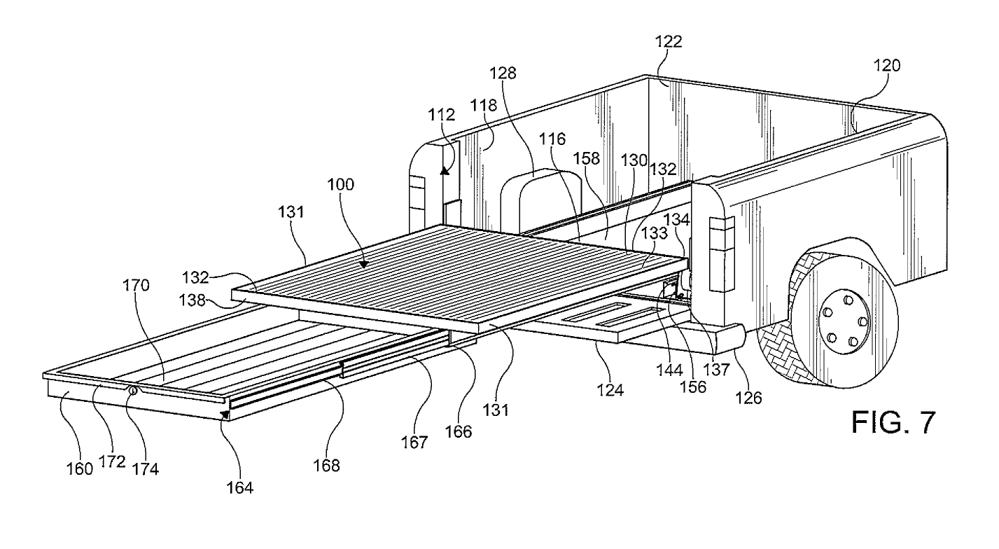

FIGS. 4-7 show an extension apparatus 100 for use in a truck bed 120 according to an embodiment of the invention. It is understood that the extension apparatus 100 is not limited to use in a truck bed 112 and can be used with other mounting structures as desired. The truck bed 112 has a bottom wall 116, opposing upright sidewalls 118, 120, a front wall 122, and a pivotal tailgate 124. The tailgate 124 is located above a rear bumper 126 and pivotal between an open position and a closed position. As shown in FIG. 7, an interior of the truck bed 112 includes upwardly projecting wheel wells 128 which are centrally formed in each sidewall 118, 120.

The extension apparatus 100 shown in FIGS. 4-7 includes an elongate, substantially planar working table 130. The working table 130 is generally rectangular shaped and is sized to fit within the truck bed 112 between the wheel wells 128. In certain embodiments, the working table 130 includes a pair of opposing side members 131 coupled together by end members 132 extending therebetween. The members 131, 132 can be formed from any suitable material such as aluminum, steel, stainless steel, hardened plastic, or other suitable lightweight rigid material, for example. The members 131, 132 form a frame which receives and retains a rigid plate (not shown) such as a sheet of aluminum, steel, stainless steel, hardened plastic, plywood, oriented strand board (OSB), medium density fiberboard (MDF), or other suitable lightweight rigid material, for example. It is understood that the side members 131 and the end members 132, as well as the plate can be integrally formed if desired to simplify a manufacture of the working table 130.

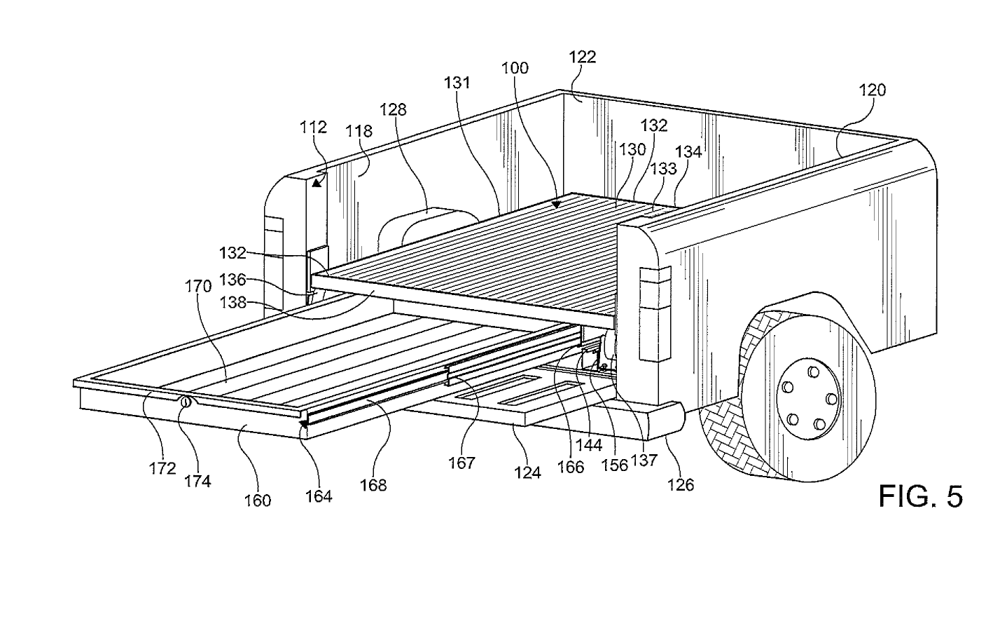

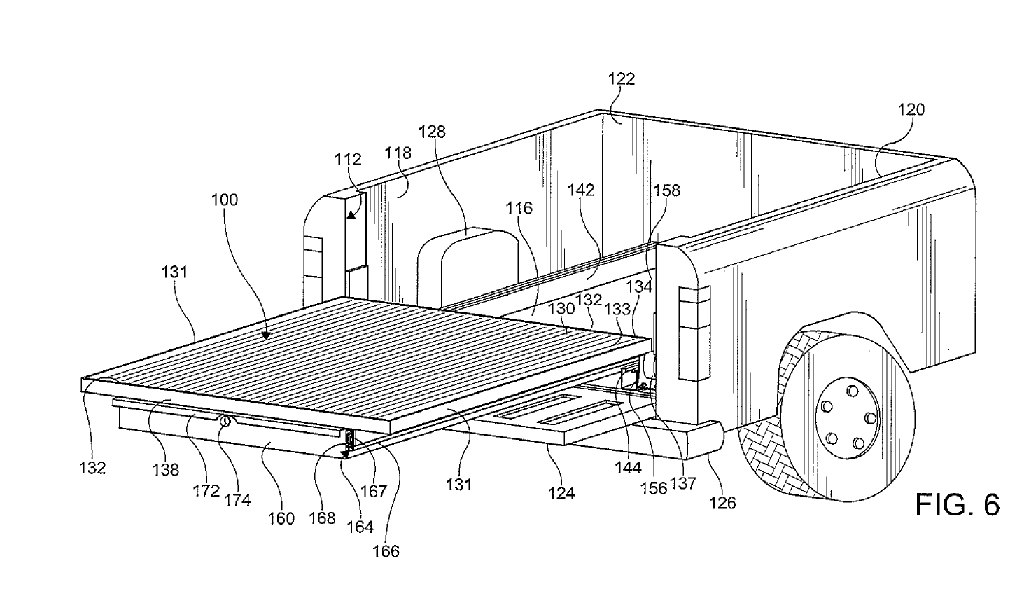

An upper surface of the working table 130 may receive thereon or be coated with a non-slip material 133 such as a rubber material, for example. A lower surface of the working table 130 includes a first pair of spaced-apart rollers (not shown) affixed thereto adjacent a front edge 134 of the working table 130 proximate the front wall 122 of the truck bed 112. A second pair of spaced-apart rollers 136, 137, shown in FIGS. 4-5 and 7, is affixed to the bottom wall 116 of the truck bed 112 proximate the tailgate 124 and rollingly contacts the lower surface of the working table 130. The first pair of rollers and the second pair of rollers 136, 137 permit a lateral movement along a longitudinal axis of the working table 130 from a retracted position, entirely within the truck bed 112, as shown in FIGS. 4-5, to an extended position, as shown in FIGS. 6-7. In the extended position, the working table 130 increases a useable length of the truck bed 112 by extending from adjacent the wheel wells 128 to past the tailgate 124. It is understood that the lateral movement of the working table 130 can be caused by a manual actuation (e.g. a user) or an automatic actuation (e.g. a drive motor), for example. Additionally, a rear edge 138 of the working table 130 may have at least one reflector (not shown) disposed thereon to indicate to other motorists a location of the working table 130 during use thereof.

The working table 30 shown is slidingly coupled to the truck bed 112 by a pair of spaced-apart U-shaped rails 142, 144 for receiving the first pair of rollers adjacent the front edge 134 of the working table 130 therein. The rails 142, 144 are disposed in the truck bed 112 substantially parallel to the sidewalls 118, 120. The rails 142, 144 guide the lateral movement of the working table 130 between the retracted and the extended position. A first end of each of the rails 142, 144 proximate the front wall 122 of the truck bed 112 is interconnected to a frame rail (not shown) which is fixedly coupled to the truck bed 112. It is understood that the frame rail and the rails 142, 144 can be fixedly or releaseably coupled to the truck bed 112 by any means as desired such as by fasteners, quick release connectors, welds, adhesive, and the like, for example. A second end 154, 156 of the rails 142, 144, respectively, can also fixedly or releaseably coupled to the truck bed 12 by any means as desired such as by fasteners, quick release connectors, welds, clamps, adhesive, and the like, for example. Each of the second ends 154, 156 may include an end cap (not shown) to militate against undesired disengagement of the working table 130 from the rails 142, 144.

As shown in FIGS. 6-7, the rails 142, 144 and the working table 130 define a compartment 158 therebetween. It is understood that the compartment 158 can have any size and shape as desired. The size of the compartment 158 can be modified by adjusting a spacing between the rails 142, 144, a height of the rails 142, 144, a width of the rails 142, 144, and a spacing between the bottom wall 116 of the truck bed 112 and the working table 130, for example. The rollers 136, 137 proximate the tailgate 124 are located outside of the second ends 154, 156 of the rails 142, 144, between the rails 142, 144 and the sidewalls 118, 122 of the truck bed 112.

The working table 130 can be slidingly coupled to the truck bed 112 by other means as desired such as by ball bearing slides, roller bearing slides, rack and pinion gears, and the like, for example. In a non-limiting example, the other means to slidingly couple the working table 130 to the truck bed 112 is a slide mechanism. The slide mechanism is coupled to the lower surface of the working table 130 and the truck bed 112, simplifying an operation and structure of the extension apparatus 100 by eliminating the need for the first pair of rollers, the second pair of rollers 136, 137, the rails 142, 144, and the frame rail, for example. It is further understood that the working table 130 may be releaseably secured in the retracted position within the truck bed 112 or in the extended position by a plurality of locking mechanisms (not shown). The locking mechanism can be any locking mechanism as desired such as a locking pin, a hook and eye latch, a push button switch, a toggle clamp, and the like, for example.

A drawer 160 slidingly disposed in the compartment 158. The drawer 160 shown is selectively positionable between a closed position, as shown in FIGS. 4 and 6, and an open position, as shown in FIGS. 5 and 7. The drawer 160 shown operates independently from an operation of the working table 130. A pair of slide mechanisms 162, 164 slidingly couples the drawer 160 to a lower surface of the working table 130. The slide mechanisms 162, 164 permit a lateral movement of the drawer 160 between the open position and the closed position. It is understood that the drawer 160 can be slidingly coupled to the working table 130 by any means as desired such as by ball bearing slides, roller bearing slides, rack and pinion gears, and the like, for example. As shown in FIGS. 5-7, each of the slide mechanisms 162, 164 includes an outer slide 166, an intermediate slide 167, and an inner slide 168. The inner slide 168 is slidingly received in the intermediate slide 167, and the intermediate slide 167 is slidingly received in the outer slide 166. The outer slides 166 are affixed to the lower surface of the working table 130 and the inner slides 168 are affixed to opposing side surfaces of the drawer 160.

The drawer 160 shown is generally rectangular shaped and is sized to fit within the compartment 158 formed between the rails 142, 144 and the working table 130. In a non-limiting example, the drawer 160 has a width of about four feet, a length of about six feet, and a depth of about six inches. It is understood that the drawer 160 have any size and shape as desired. The drawer 160 may be formed from any suitable material such as aluminum, steel, stainless steel, hardened plastic, or any other lightweight rigid material, for example, and formed to include features to maximize a strength and a rigidity thereof such as a plurality of protuberances, for example. A bottom surface of an interior of the drawer 160 may receive thereon or be coated with a non-slip material 170 such as a rubber material, for example. A lower surface of the drawer 160 may include a plurality of rollers (not shown) affixed thereto to facilitate a rolling contact between the drawer 160 and the bottom wall 116 of the truck bed 112. The drawer 160 may also include a handle 172 formed therein or disposed thereon to facilitate an opening and a closing of the drawer 160 by a manual means. It is understood that the drawer 160 can be configured to be opened and closed by an automated means such as by a drive motor, for example, if desired. It is further understood that the drawer 160 can include a locking mechanism 174 to militate against undesired access to or opening of the drawer 60, especially during a positioning of the working table 130.

In operation, when an extended truck bed 112 is desired, the tailgate 124 is pivoted to the open position and one of the locking mechanisms of the working table 130 is released. The working table 130 is then laterally moved from the retracted position to the extended position. As the working table 130 is moved to the extended position, the first pair of rollers travels within the rails 142, 144 from the first ends thereof towards the second ends 154, 156 and the lower surface of the working table 130 rollingly contacts the second pair of rollers 136, 137. Once in the extended position, the working table 130 is releaseably secured by another one of the locking mechanisms to maintain the working table 130 in the extended position.

When the extended truck bed 112 is no longer desired, the locking mechanism maintaining the working table 130 in the extended position is released. Thereafter, the working table 130 is laterally moved from the extended position to the retracted position. As the working table 130 is moved to the retracted position, the first pair of rollers travels within the rails 142, 144 from the second ends 154, 156 thereof towards the first ends and the lower surface of the working table 130 rollingly contacts the second pair of rollers 136, 137. Once in the retracted position, the working table 130 is releaseably secured by one of the locking mechanisms to maintain the working table 130 in the retracted position. The tailgate 124 is then pivoted and secured in the closed position.

When access to the drawer 160 is desired, the working table 130 can be positioned in either the retracted position or the extended position. The drawer 160 is then opened using either the manual means or the automated means. As the drawer 160 is moved to the opened position, the inner slides 168 of the slide mechanisms 162, 164 travel within the intermediate slides 167 thereof and the intermediate slides 167 travel within the outer slides 166 thereof away from the front wall 122 of the truck bed 112. Once access to the interior of the drawer 160 is no longer desired, the drawer 160 is then closed using either the manual means or the automated means. In particular, the inner slides 168 of the slide mechanisms 162, 164 travel within the intermediate slides 167 and the intermediate slides 167 travel within the outer slides 166 toward the front wall 122 of the truck bed 112, thereby closing the drawer 160.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. An extension apparatus comprising:
a working table movably coupled to a mounting structure, the working table selectively positionable between a retracted position and an extended position; and
an extensible drawer disposed between the working table and the mounting structure, the extensible drawer selectively positionable between a closed position and a fully-open position.

2. The apparatus according to claim 1, wherein the working table is movably coupled to the mounting structure by at least one rail.

3. The apparatus according to claim 1, wherein the working table includes a non-slip material disposed thereon.

4. The apparatus according to claim 1, wherein the extensible drawer is movably coupled to the working table.

5. The apparatus according to claim 1, further comprising at least one slide mechanism, wherein the extensible drawer is movably coupled to the working table by the at least one slide mechanism.

6. The apparatus according to claim 5, wherein the at least one slide mechanism includes an inner slide, an outer slide, and an intermediate slide.

7. The apparatus according to claim 1, wherein the extensible drawer includes a non-slip material dispose on an interior surface thereof.

8. The apparatus according to claim 1, wherein the extensible drawer includes at least one protuberance formed therein to maximize a strength and a rigidity thereof.

9. The apparatus according to claim 1, wherein the extensible drawer includes a lid disposed thereon to militate against an undesired access to an interior thereof.

10. The apparatus according to claim 1, wherein at least one of the working table and the extensible drawer includes at least one locking mechanism to maintain a position thereof.

11. The apparatus according to claim 1, wherein the extensible drawer is configured to be accessible to a user when the working table is positioned in at least one of the extended position and an intermediate position between the extended position and the retracted position.

12. The apparatus according to claim 1, wherein the mounting structure is a truck bed.

13. The apparatus according to claim 1, wherein the working table and the extensible drawer are configured to move independently of one another.

14. An extension apparatus comprising:
a working table movably coupled to a mounting structure, the working table selectively positionable between a retracted position and an extended position; and
an extensible drawer movably coupled to the working table between the working table and the mounting structure, the extensible drawer selectively positionable between a closed position and a fully-open position.

15. The apparatus according to claim 14, wherein the working table is movably coupled to the mounting structure by at least one rail.

16. The apparatus according to claim 14, further comprising at least one slide mechanism, wherein the extensible drawer is movably coupled to the working table by the at least one slide mechanism.

17. The apparatus according to claim 16, wherein the at least one slide mechanism includes an inner slide, an outer slide, and an intermediate slide.

18. The apparatus according to claim 14, wherein the extensible drawer is configured to be accessible to a user when the working table is positioned in at least one of the extended position and an intermediate position between the extended position and the retracted position.

19. The apparatus according to claim 14, wherein the mounting structure is a truck bed.

20. An extension apparatus comprising:
a working table movably coupled to a truck bed, the working table selectively positionable between a retracted position and an extended position; and
an extensible drawer movably coupled to the working table between the working table and the truck bed, the extensible drawer selectively positionable between a closed position and a fully-open position, wherein the extensible drawer is configured to be accessible to a user when the working table is positioned in at least one of the extended position and an intermediate position between the extended position and the retracted position.
